(19) United States
(12) Patent Application Publication
(10) Pub. No.: US 2024/0421665 A1
(43) Pub. Date: Dec. 19, 2024

(54) DUAL SIDED STATOR COOLING SYSTEM

(71) Applicant: Atieva, Inc., Newark, CA (US)

(72) Inventors: Dimitri Bassis, Union City, CA (US); Emad Dlala, Pleasanton, CA (US); Barnaby James Gerard Lewis, San Francisco, CA (US); Mohammad Mahmoudi, Fremont, CA (US); Jeremy Mayer, Mountain View, CA (US); Shun-Cheng Hung, Taipei City (TW); Anandakumar Subbiah, Newark, CA (US); Vivek Meenakshi Sundaram, Newark, CA (US)

(21) Appl. No.: 18/705,054

(22) PCT Filed: Oct. 6, 2022
(86) PCT No.: PCT/US2022/077712

§ 371 Date: Apr. 26, 2024

Related U.S. Application Data
(60) Provisional application No. 63/263,148, filed on Oct. 27, 2021.

(51) Int. Cl. H02K 9/19; H02K 3/50

(52) U.S. Cl. CPC H02K 9/19; H02K 3/50; H02K 2203/09

(57) ABSTRACT

A dual axial cooling system for an electric motor includes a cover assembly provided at first and second axial ends of a stator of the electric motor. Each cover assembly includes a first side portion that is oriented so as to face an interior of the stator, with a plurality of holes formed in the first side portion. A second side portion is coupled to the first side portion, so that a passage is formed between the first and second side portions. A supply nozzle portion is in fluid communication with the plurality of openings via the passage defined between the first and second side portions. The plurality of openings receive cooling fluid from the supply nozzle portion, and discharge the cooling fluid in an axial direction, from each axial end portion of the stator, to provide axial cooling in two axial directions into the stator.

### CROSS-REFERENCE TO RELATED APPLICATION

This application claims priority to U.S. Provisional Patent Application No. 63/263,148, filed on Oct. 27, 2021, entitled “DUAL SIDED STATOR COOLING SYSTEM,” the disclosure of which is incorporated by reference herein in its entirety.

### FIELD

This relates to a motor assembly of an electric vehicle and, more particularly, to a cooling system for cooling a motor assembly of an electric vehicle.

### BACKGROUND

High performance electric vehicles rely on efficient and effective cooling to achieve desired levels of performance and reliability, regardless of ambient conditions and/or driving conditions and/or driving practices. Effectiveness of many of the current techniques for cooling the motor of an electric vehicle are somewhat limited in their ability to effectively draw heat out of the motor components. For example, some cooling systems rely on cooling channels within stator windings of the electric motor, radial injection of cooling media, or cooling fluid, such as oil directed at the stator windings, combinations of various cooling subsystems directing cooling to specific components of the electric motor, and the like. These types of cooling systems may be somewhat ineffective and/or inefficient, or only partially effective and/or complex and costly. This can be in part due to, for example, the non-homogeneity of stator windings, loss of velocity of the cooling media as it travels through the electric motor, non-uniform flow distribution of the cooling media into and through the electric motor, impeding of the flow of cooling media due to some components due to the arrangement and placement of other components of the electric motor such as, for example, busbars, support structure and the like, ineffective and/or inefficient draining of cooling media from the electric motor/pooling of the cooling media, and other such factors. This can result in hotspots which can degrade component performance and reliability.

### SUMMARY

In one general aspect, an axial cooling system for a drive system includes at least one cover assembly configured to be coupled to an axial end portion of an electric motor of the drive system. The at least one cover assembly may include a first side portion configured to face the stator; a second side portion coupled to the first side portion so as to form a passage therebetween; a plurality of openings defined in the first side portion; and a supply nozzle portion in fluid communication with the plurality of openings via the passage defined between the first side portion and the second side portion, wherein the plurality of openings are configured to receive cooling fluid from the supply nozzle portion, and to discharge the cooling fluid in an axial direction toward a stator of the electric motor.

In some implementations, the at least one cover assembly includes a first cover assembly configured to be coupled to a first axial end portion of the electric motor, wherein the first cover assembly is configured to discharge the cooling fluid in a first axial direction and onto stator end windings at the first axial end portion of the electric motor; and a second cover assembly configured to be coupled to a second axial end portion of the electric motor, wherein the second cover assembly is configured to discharge the cooling fluid in a second axial direction and onto stator end windings at the second axial end portion of the electric motor.

In some implementations, the plurality of openings in the first side portion are arranged circumferentially about a central axis of the at least one cover assembly, corresponding to a central longitudinal axis of the stator.

In some implementations, the plurality of openings in the first side portion are arranged irregularly about a central axis of the at least one cover assembly.

In some implementations, a size and a shape of the plurality of openings are substantially the same, and wherein the plurality of openings are arranged substantially equidistant from each other along a circumferential portion of the first side portion of the at least one cover assembly, corresponding to an arrangement of stator end windings at the axial end portion of the electric motor.

In some implementations, the axial cooling system includes a plurality of busbars configured to supply power to the stator. The plurality of busbars may be arranged circumferentially between an axial end portion of the stator and the at least one cover assembly, with spaces formed between adjacent busbars of the plurality of busbars such that cooling fluid discharged through the plurality of openings in the at least one cover assembly flows through the spaces formed between adjacent busbars.

In some implementations, each of the plurality of busbars is individually coated with a dielectric material.

In some implementations, the axial cooling system also includes a first holder positioned at an inner circumferential position relative to the plurality of busbars; and a second holder positioned at an outer circumferential position relative to the plurality of busbars. The first holder and the second holder may be configured to secure a position of the plurality of busbars relative to a plurality of stator end windings at the axial end portion of the stator.

In some implementations, the second holder includes a plurality of leg portions each having a first end coupled to a busbar of the plurality of busbars and a second end portion coupled to the axial end portion of the stator; and a plurality of windows formed between adjacent leg portions of the plurality of leg portions.

In some implementations, the first holder and the second holder are injection molded.

In some implementations, the plurality of openings defined in the first side portion comprises a plurality of first openings, the at least one cover assembly further comprising a second plurality of openings defined in the second side portion.

In some implementations, the supply nozzle portion is in fluid communication with the first plurality of openings and with the second plurality of openings via the passage defined between the first side portion and the second side portion.

In some implementations, the first plurality of openings are configured to receive cooling fluid from the supply nozzle portion and to discharge the cooling fluid in an axial direction toward a stator of a first electric motor of the drive system, the first electric motor being positioned at a first side of the at least one cover assembly; and the second plurality of openings are configured to receive cooling fluid from the supply nozzle portion and to discharge the cooling fluid in an axial direction toward a stator of a second electric motor of the drive system, the second electric motor being positioned at a second side of the at least one cover assembly.

In another general aspect, an axial cooling system for a drive system includes at least one cover assembly configured to be coupled to an axial end portion of an electric motor of the drive system. The at least one cover assembly may include a first side portion configured to face the stator; a second side portion coupled to the first side portion so as to form a passage therebetween; and means for receiving cooling fluid into the passage, and for discharging the cooling fluid from the passage in an axial direction toward a stator of the electric motor.

In some implementations, the at least one cover assembly includes a first cover assembly configured to be coupled to a first axial end portion of the electric motor, wherein the first cover assembly is configured to discharge the cooling fluid in a first axial direction and onto stator end windings at the first axial end portion of the electric motor; and a second cover assembly configured to be coupled to a second axial end portion of the electric motor, wherein the second cover assembly is configured to discharge the cooling fluid in a second axial direction and onto stator end windings at the second axial end portion of the electric motor.

In some implementations, the plurality of openings in the first side portion are arranged circumferentially about a central axis of the at least one cover assembly, corresponding to an arrangement of stator end windings at the axial end portion of the electric motor.

In some implementations, the axial cooling system also includes a plurality of busbars configured to supply power to the stator. The plurality of busbars may be arranged circumferentially between an axial end portion of the stator and the at least one cover assembly, with spaces formed between adjacent busbars of the plurality of busbars such that cooling fluid discharged through the plurality of openings in the at least one cover assembly flows through the spaces formed between adjacent busbars.

In some implementations, the axial cooling system also includes a first holder positioned at an inner circumferential position relative to the plurality of busbars; and a second holder positioned at an outer circumferential position relative to the plurality of busbars. The first holder and the second holder may be configured to secure a position of the plurality of busbars relative to a plurality of stator end windings at the axial end portion of the stator.

In some implementations, the plurality of openings defined in the first side portion comprises a plurality of first openings, and wherein the at least one cover assembly further comprises a second plurality of openings defined in the second side portion, wherein the plurality of first openings and the plurality of second openings are in fluid communication with the passage defined between the first side portion and the second side portion.

In some implementations, the first plurality of openings are configured to discharge cooling fluid from the passage in a first axial direction toward a stator of a first electric motor of the drive system, the first electric motor being positioned at a first side of the at least one cover assembly; and the second plurality of openings are configured to discharge cooling fluid from the passage in a second axial direction toward a stator of a second electric motor of the drive system, the second electric motor being positioned at a second side of the at least one cover assembly.

The details of one or more implementations are set forth in the accompanying drawings and the description below. Other features will be apparent from the description and drawings, and from the claims.

### BRIEF DESCRIPTION OF THE DRAWINGS

In the drawings, like reference symbols or numerals are used to indicate like elements wherever practical

FIG. 1A is a schematic view of an example dual-sided stator cooling system.

FIG. 1B is a schematic view of an example dual-sided stator cooling system.

FIG. 1C is a schematic view of an example dual-sided stator cooling system.

FIGS. 1D-1G are schematic axial end views of example cover assembly portions of the example system shown in FIG. 1A.

FIG. 2A is a side view, FIG. 2B is a first perspective view, and FIG. 2C is a second perspective view of an example electric motor, in accordance with implementations described herein.

FIG. 3A is a first perspective view, and FIG. 3B is a second perspective view, of an example cover assembly shown in FIGS. 2A-2C, in accordance with implementations described herein.

FIGS. 3C and 3D are cross-sectional views taken along line A-A of FIG. 3A.

FIG. 4A is a first perspective view, and FIG. 4B is a second perspective view, of an example cover assembly shown in FIGS. 2A-2C, in accordance with implementations described herein.

FIGS. 4C and 4D are cross-sectional views taken along line B-B of FIG. 4A

FIG. 5A is a side view, FIG. 5B is a perspective view, and FIG. 5C is a partial perspective view, of a portion of the example electric motor shown in FIGS. 2A-2C, in accordance with implementations described herein.

### DETAILED DESCRIPTION

Cooling systems, in accordance with implementations described herein, are generally applicable to electric motors, and in particular to electric motors for electric vehicles (EVs). Hereinafter, the term EV may be used to refer to an all-electric vehicle, a plug-in hybrid vehicle, a hybrid vehicle including an electric drive system, and other applications having at least one electric motor.

A cooling system, in accordance with implementations described herein, can improve cooling of an electric motor, can reduce hotspots throughout the electric motor, and/or can enhance performance of the electric motor and/or the EV. A cooling system, in accordance with implementations described herein, can provide bi-directional cooling to the electric motor. In some implementations, an arrangement of openings in a structure at one or more axial end portions of the electric motor can provide for axial introduction of cooling media, or cooling fluid, into the electric motor. In some implementations, an arrangement of busbars at one or more axial end portions of the electric motor can facilitate the distribution of cooling media, or cooling fluid, into the electric motor and/or the draining of cooling media, or cooling fluid, from the electric motor.

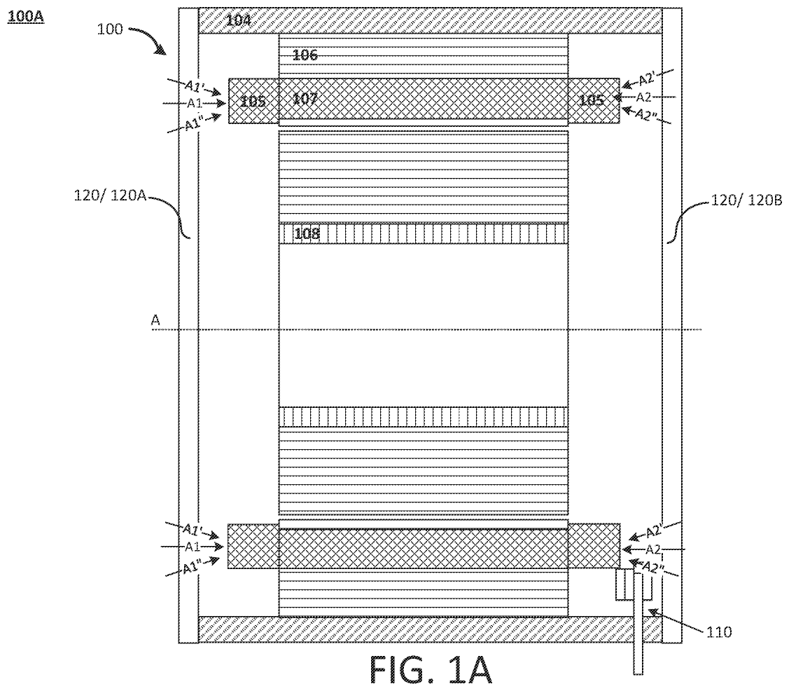

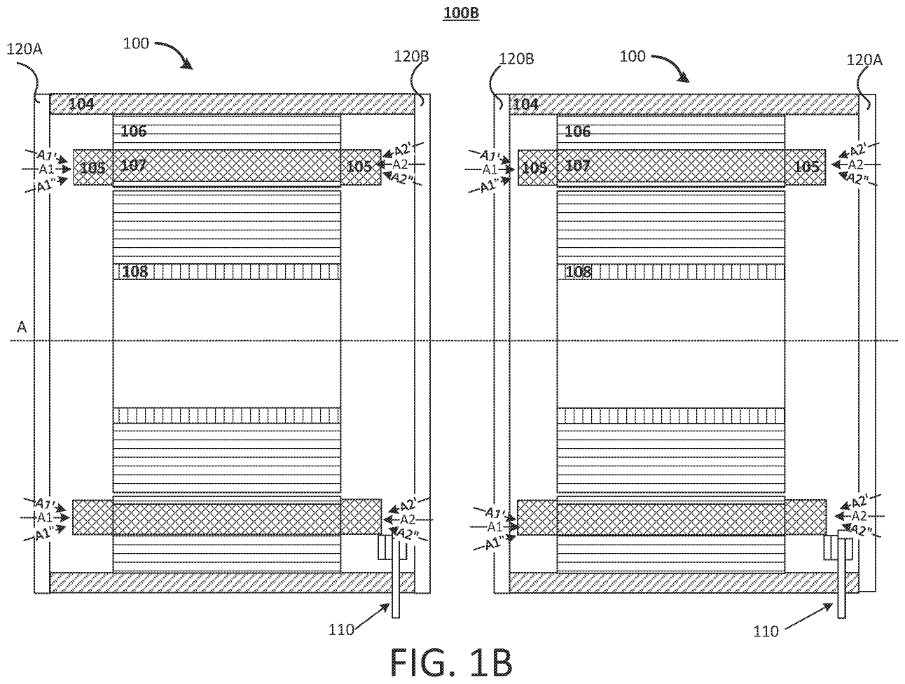

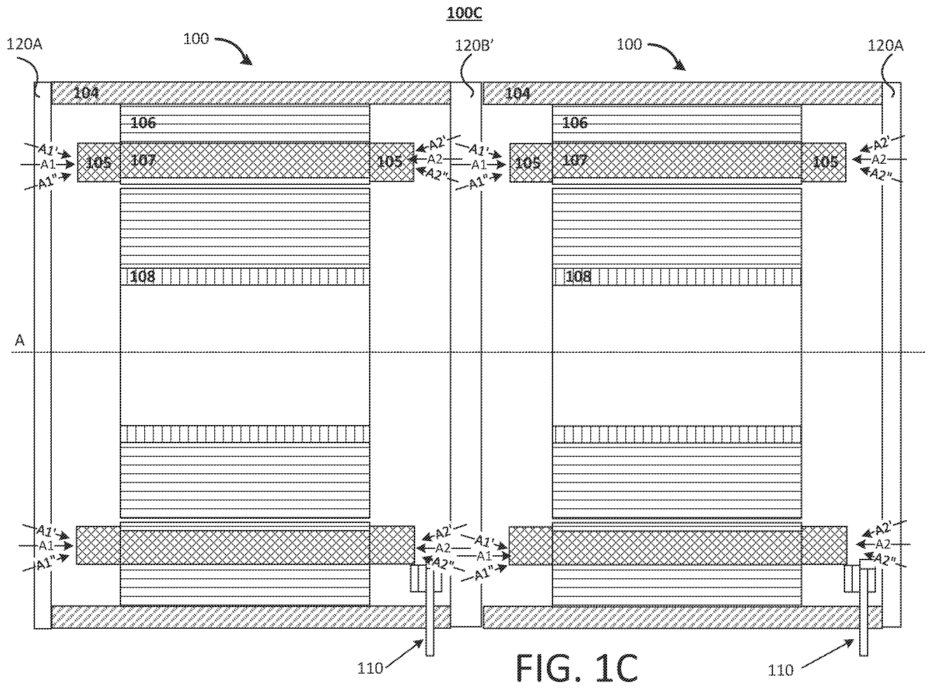

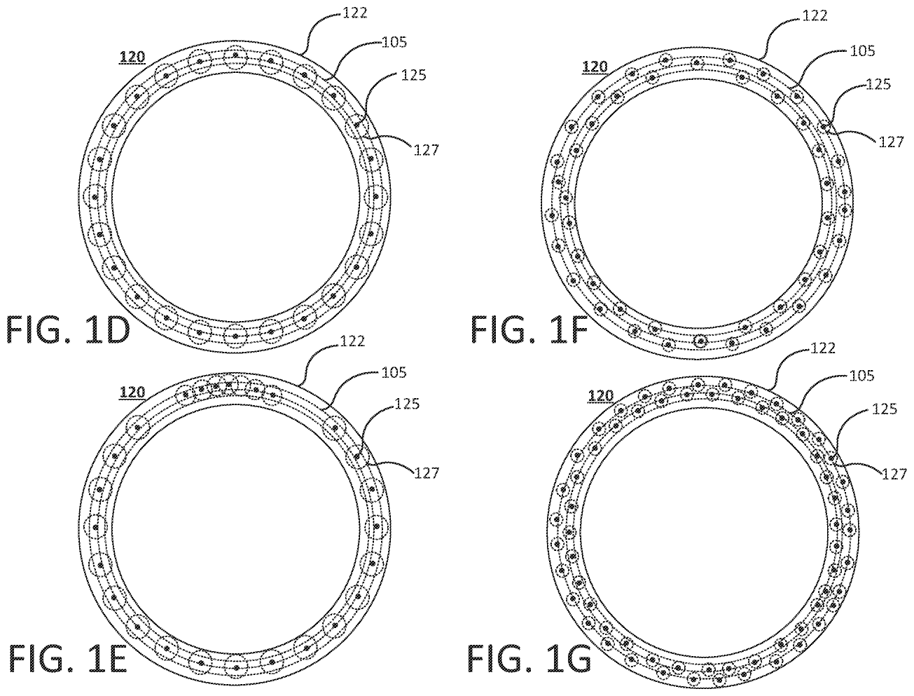

FIGS. 1A-1C are schematic cross-sectional views of example drive systems 100 for an electric vehicle. In particular, FIG. 1A is a schematic cross-sectional view of a first example drive system 100A for an electric vehicle, illustrating a single drive system arrangement. FIG. 1B is a schematic cross-sectional view illustrating a second example drive system 100B, including an example dual drive system arrangement. FIG. 1C is a schematic cross-sectional view illustrating a third example drive system 100C, including another dual drive system arrangement. The example dual drive system arrangements shown in FIGS. 1B and 1C may be implemented, for example, in a drive system of an electric vehicle, in which each wheel of an axle is powered by its own electric motor.

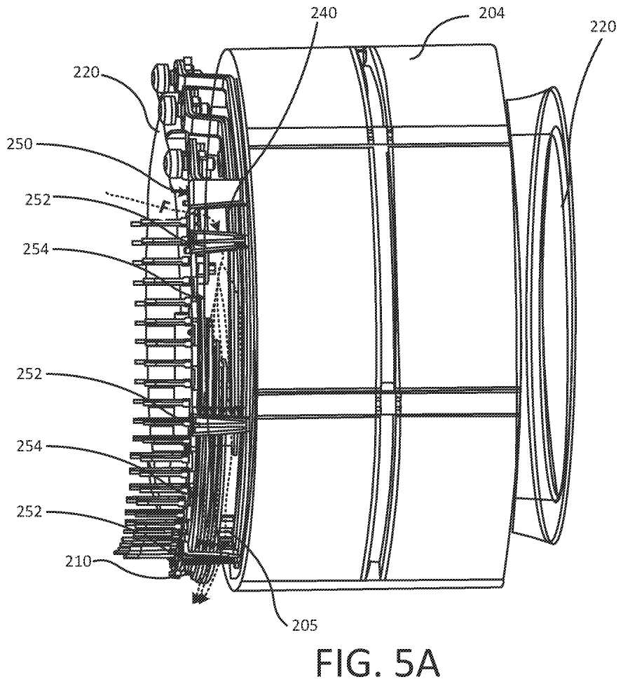

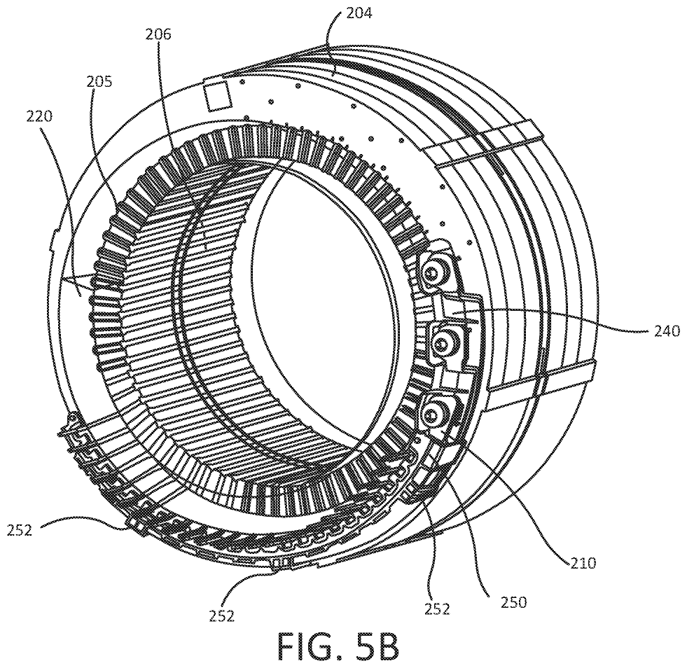

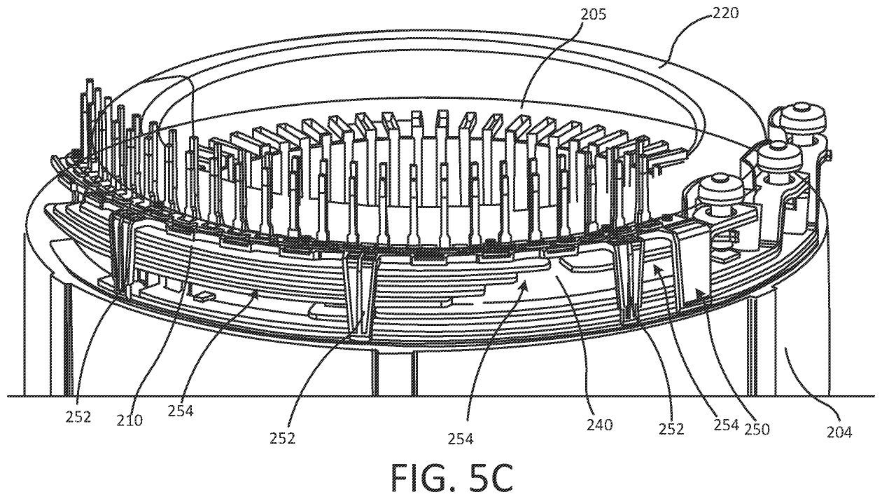

The drive system 100 includes a rotor 108 and a stator 106 positioned within a motor casing 104. In the example schematic arrangements shown in FIGS. 1A-1C, busbars 110 are positioned at an axial end portion of the stator 106 to distribute power to the stator 106. In particular, the busbars 110 are positioned at an axial end portion of the stator 106, proximate end turns 105, or end windings 105, of the stator 106, extending from a plurality of stator windings 107 of the stator 106. As FIGS. 1A-1C are cross-sectional schematic views, only a portion of the busbars 110 are illustrated. The busbars 110 will be more easily visible in examples to be described in more detail hereinafter with respect to, for example, FIGS. 5A-5C. A cover assembly 120 may be positioned at one or both axial end portions of the assembled rotor 108 and stator 106. In the example arrangement shown in FIG. 1A, a first cover assembly 120A is positioned at a first axial end portion of the electric motor, and a second cover assembly 120B is positioned at a second axial end portion of the electric motor.

In the arrangement shown in FIG. 1B, a first cover assembly 120A is positioned at a first axial end portion of each of the two electric motors, and a second cover assembly 120B is positioned at a second axial end portion of each of the two electric motors. In the arrangement shown in FIG. 1B, a first cover assembly 120A is positioned at a first axial end portion of each of the two electric motors, and a shared/dual sided second cover assembly 120B′ is positioned between the second axial end portions of the two electric motors. In a situation in which such a dual drive system is implemented, the shared/dual sided second cover assembly 120B′ may allow for cooling at the respective second axial end portions of the two electric motors to be provided via the single, shared second cover assembly 120B′.

FIGS. 1D-E are schematic axial end views of example cover assemblies 120 that can be included in the example arrangements shown in FIGS. 1A-1C. The example cover assemblies 120 may include a plurality of openings 125 formed in a ring portion 122. The ring portion 122 and the openings 125 may be positioned corresponding to the stator end windings 105. The openings 125 may be formed so that cooling media, or cooling fluid, flowing through the openings 125 is directed at the stator end windings 105 for cooling, with an example impingement area 127 illustrated for each of the openings. FIGS. 1D-1G illustrate some example arrangements of the openings 125 formed in the ring portion 122 of the cover assembly 120, and some example impingement areas 127 associated with the example arrangements of openings 125. In some examples, the openings 125 can be arranged circumferentially about a central axis of the cover assembly 120. In some examples, the plurality of openings 125 can be arranged substantially equidistant from each other. In some examples, the openings 125 can have different sizes and/or combinations of sizes, different shapes and/or combinations of shapes. In some examples, the cover assembly 120 can include openings 125 having different sizes and/or combinations of sizes, different shapes and/or combinations of shapes that produce impingement areas 127 having different sizes and/or shapes and or combinations thereof. In some examples, the openings 125 may be arranged symmetrically about a central plane of the cover assembly 120, or asymmetrically, or in a staggered or irregular pattern. In some examples, the openings 125 may have a substantially axial orientation (for example, with respect to a central longitudinal axis of the drive system 100) extending through the ring portion 122 of the cover assembly 120, thus discharging a substantially axial flow of cooling fluid toward the stator end windings 105. In some examples, one or more of the openings 125 may be oriented at an angle with respect to the axial direction, thus discharging cooling fluid at a corresponding angle, and producing a corresponding impingement area 127. When designing the cover assembly 120, a number and/or a size and/or a shape and/or an arrangement and/or an orientation of the openings 125 formed in the ring portion 122 of the cover assembly 120 may be chosen based on, for example, electromagnetic and thermal operating conditions, operational speeds of the electric motor, operating temperatures of the electric motor, cooling characteristics, flow velocity and the like of the cooling media, or cooling fluid, and other such factors.

The openings 125 in the ring portion 122 of the cover assembly 120 may direct cooling media, or cooling fluid, such as, for example, oil, into the electric motor in at least one of a first direction and/or a second direction. In some examples, the first direction and/or the second direction may be a substantially axial first direction A1 and/or a substantially axial second direction A2, corresponding to a longitudinal axis A of the example drive systems 100, as shown in FIGS. 1A-1C. In some examples, the first direction and/or the second direction may be a direction that is offset from the axial direction, such as the example first directions A1′ and A1 “, and the example second directions A2′ and A2” shown in FIGS. 1A-1C.

In the example arrangement shown in FIG. 1C, the second cover assembly 120B′ is a dual sided, or shared, cover assembly, simply for purposes of discussion and illustration. In some examples, the first cover assembly 120A may be positioned between the two electric motors and function as the shared cover assembly, with second cover assemblies provided at the two opposite axial ends of the two electric motors. In either case, the shared cover assembly 120 (the second cover assembly 120B in the example shown in FIG. 1C) positioned between the two electric motors may include openings 125 in a ring portion 122 on the first side of the second cover assembly 120 that direct cooling media, or cooling fluid, such as, for example, oil, into a first of the two electric motors in for example, the substantially axial second direction A2 and/or the example second directions A2′ and/or A2″ that are offset from the axial direction. Similarly, openings in a ring portion 122 on the second side of the shared cover assembly 120 (the second cover assembly 120B in the example shown in FIG. 1C) may direct cooling media, or cooling fluid, such as, for example, oil, into a second of the two electric motors in for example, the substantially axial first direction A1 and/or the example first directions A1′ and/or A1″ that are offset from the axial direction. As noted above, the shared cover assembly 120 positioned between the two electric motors may include features to be described in more detail below with respect to the second cover assembly 120B, or instead may include features to be described in more detail below with respect to the first cover assembly 120A.

This arrangement of components and the introduction of cooling media, or cooling fluid, into the electric motor from the opposite axial end portions of the stator 106, at the stator end windings 105 in this manner may improve the flow of cooling media, or cooling fluid, into the electric motor, may provide for more uniform distribution of the cooling media, or cooling fluid, through the electric motor, and may improve drainage of the cooling media, or cooling fluid, from the electric motor.

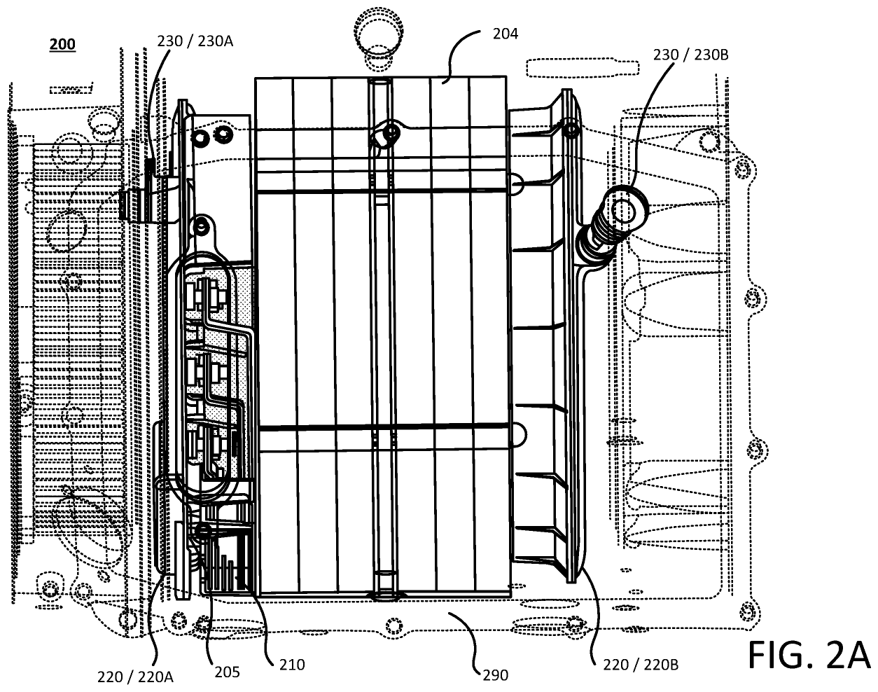

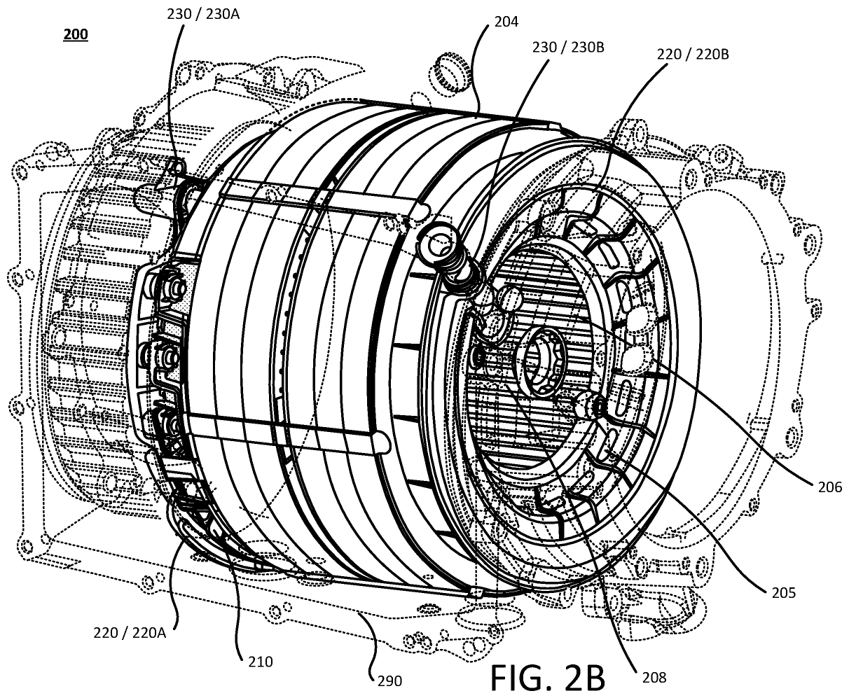

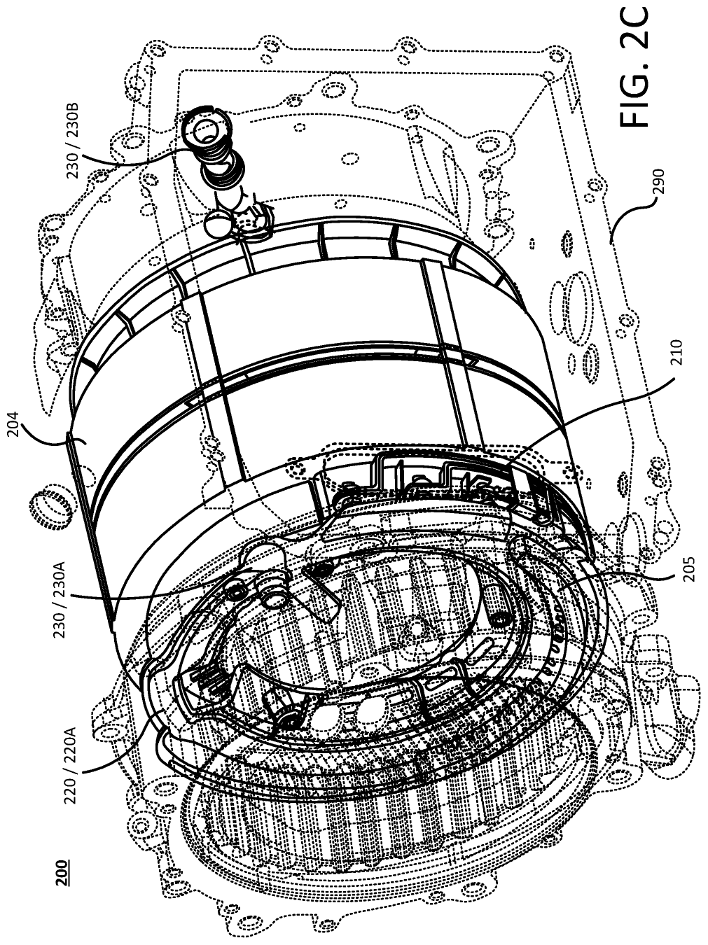

FIG. 2A is a side view, FIG. 2B is a first perspective view, and FIG. 2C is a second perspective view, of an example electric motor, for example, an electric motor for an electric vehicle, that may make use of the cooling system in accordance with implementations described herein. Hereinafter, the cooling system will be described in a configuration that makes use of substantially axial discharge of cooling fluid for cooling of stator components, simply for purposes of discussion and illustration. As noted above, cooling fluid may be discharged in directions that are somewhat offset from the axial direction to provide cooling to the stator components. Similarly, the cooling system will be described with respect to a drive system including a single electric motor, simply for purposes of discussion and illustration. The principles to be described herein can be applied to other arrangements of electric motors, such as the example dual drive system(s) shown in FIGS. 1B and 1C.

The example electric motor 200 includes a rotor 208 and a stator 206 housed in a motor housing 204. Cover assemblies 220 are positioned at axial end portions of the motor housing 204, at positions corresponding to the stator end windings 205 and busbars 210 at axial end portions of the stator 206. In the example arrangement shown in FIGS. 2A-2C, a first cover assembly 220A is provided at a first axial end portion of the motor housing 204, and a second cover assembly 220B is provided at a second axial and portion of the motor housing 204. Characteristics of the cover assembly(s) 120 described above with respect to any of FIGS. 1A-1G may be applicable to the example cover assemblies 220 shown in FIGS. 2A-2C. Cooling media, or cooling fluid, for example, oil, may be introduced into channels defined in the cover assembly(s) 220 through supply nozzle(s) 230 in fluid communication with the cover assembly(s) 220. In the example arrangement shown in FIGS. 2A-2C, a first supply nozzle portion 230A can supply for example, oil, for injection (for example, axial discharge in the first axial direction A1 shown in FIG. 1A) into the electric motor 200 via the first cover assembly 220A. A second supply nozzle portion 230B can supply, for example, oil, for injection (for example, axial discharge in the second axial direction A2 shown in FIG. 1A) into the electric motor 200 through the second cover assembly 220B. In some examples, the nozzle(s) 230 can receive cooling media, or cooling fluid, such as oil, from an oil supply channel (not shown in FIGS. 2A-2C). Oil that has been circulated through the electric motor 200 for cooling can be drained from the electric motor 200 via a drain channel 290.

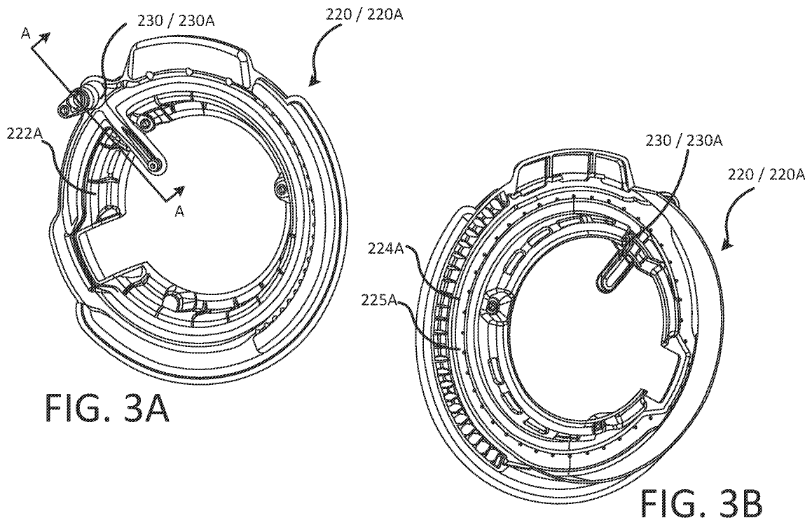

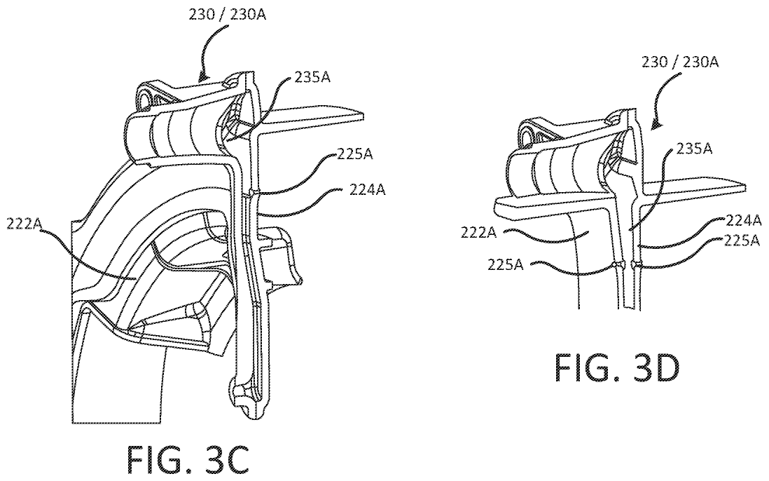

FIG. 3A is a first perspective view, and FIG. 3B is a second perspective view, of the first cover assembly 220A shown in FIGS. 2A-2C. In particular, FIG. 3A illustrates a first side portion 222A (for example, an exterior facing side portion) of the example first cover assembly 220A, and FIG. 3B illustrates a second side portion 224A (for example, an interior facing side portion) of the first cover assembly 220A, i.e., a side of the first cover assembly 220A facing the rotor 208 and the stator 206 of the example electric motor 200 in the assembled state shown in FIGS. 2A-2C. FIG. 3C is a cross-sectional view of the supply nozzle portion 230A of the first cover assembly 220A, taken along line A-A of FIG. 3A.

The example cover assembly 220A shown in FIGS. 3A-3C can include one or more openings, passages, structures and the like, to guide the flow of oil from the first supply nozzle portion 230A, through the first cover assembly 220A, for discharge out through the plurality of openings 225A formed in the first cover assembly 220A. In the example arrangement shown in FIGS. 3A-3C, the first supply nozzle portion 230A guides oil into a first inlet passage 235A, defined between the first side portion 222A and the second side portion 224A of the first cover assembly 220A. From the inlet passage 235A, the oil may be distributed substantially circumferentially throughout the interior of the first cover assembly 220A. As noted above, the openings 225A may be formed so as to correspond to the arrangement of stator end windings 205 and/or busbars 210 at the corresponding axial end portion of the stator 206. Thus, the oil can be forced out of the inlet passage 235A, for example, under pressure, through the plurality of openings 225A formed in the second side portion 224A of the first cover assembly 220A, for cooling of the busbars 210 and/or the stator end windings 205 at the corresponding axial end portion of the stator 206.

FIG. 3D is a cross-sectional view, taken at the first supply nozzle portion 230A of the example cover assembly 220A configured as a shared cover assembly to be positioned between two adjacent electric motors of a dual drive system, as illustrated in FIG. 1C. In this arrangement, the first supply nozzle portion 230A guides oil into the first inlet passage 235A, defined between the first side portion 222A (for example, a side portion facing a first of the two electric motors) and the second side portion 224A (for example, a side portion facing a second of the two electric motors). From the inlet passage 235A, the oil may be distributed substantially circumferentially throughout the interior of the first cover assembly 220A. Openings 225A in the first side portion 222A may be formed so as to correspond to the arrangement of stator end windings 205 and/or busbars 210 at the corresponding axial end portion of the stator 206 of the first of the two electric motors. Openings 225A in the second side portion 224A may be formed so as to correspond to the arrangement of stator end windings 205 and/or busbars 210 at the corresponding axial end portion of the stator 206 of the second of the two electric motors. Thus, the oil can be forced out of the inlet passage 235A, for example, under pressure, through the plurality of openings 225A formed in first side portion 222A and the second side portion 224A of the first cover assembly 220A, for cooling of the busbars 210 and/or the stator end windings 205 at the corresponding axial end portion of the stator 206 of each of the two electric motors.

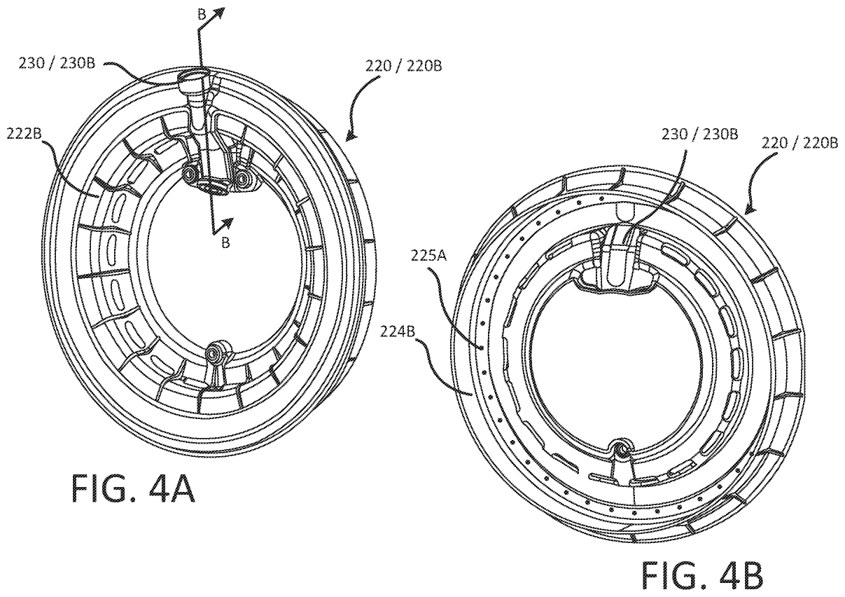

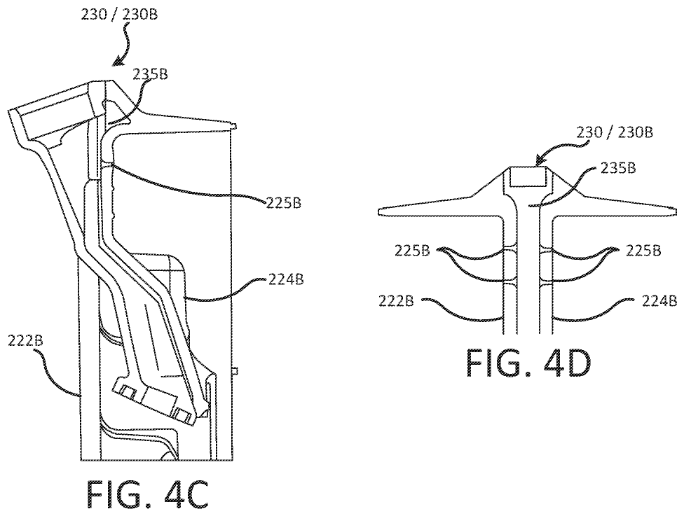

FIG. 4A is a first perspective view, and FIG. 4B is a second perspective view, of the second cover assembly 220B shown in FIGS. 2A-2C. In particular, FIG. 4A illustrates a first side (for example, an exterior facing side) of the example second cover assembly 220B, and FIG. 4B illustrates a second side (for example, an interior facing side) of the second cover assembly 220B, i.e., a side of the second cover assembly 220B facing the rotor 208 and the stator 206 of the example electric motor 200 shown in FIGS. 2A-2C. FIG. 4C is a cross-sectional view of the second supply nozzle portion 230B of the second cover assembly 220B, taken along line B-B of FIG. 4A.

The example cover assembly 220B shown in FIGS. 4A-4C can include one or more openings, passages, structures and the like, to guide the flow of oil from the second supply nozzle portion 230B, through the second cover assembly 220B, for discharge out through the plurality of openings 225B. In the example arrangement shown in FIGS. 4A-4C, the second supply nozzle portion 230B guides oil into a second inlet passage 235B, defined between the first side portion 222B (for example, the exterior facing side portion) and the second side portion 224B (for example, the interior facing side portion) of the second cover assembly 220B. From the inlet passage 235B, the oil may be distributed substantially circumferentially throughout the interior of the second cover assembly 220B. As noted above, the openings 225B may be formed so as to correspond to the arrangement of stator end windings 205 and/or busbars 210 at the corresponding axial end portion of the stator 206. Thus, the oil can be forced out of the inlet passage 235B, for example, under pressure, through the plurality of openings 225B formed in the interior facing side portion 224B of the second cover assembly 220B, for cooling of the busbars 210 and/or the stator end windings 205 at the corresponding axial end portion of the stator 206.

FIG. 4D is a cross-sectional view, taken at the second supply nozzle portion 230B of the example cover assembly 220B configured as a shared cover assembly to be positioned between two adjacent electric motors of a dual drive system, as illustrated in FIG. 1C. In this arrangement, the second supply nozzle portion 230B guides oil into the second inlet passage 235B, defined between the first side portion 222B (for example, a side portion facing a first of the two electric motors) and the second side portion 224B (for example, a side portion facing a second of the two electric motors). From the inlet passage 235B, the oil may be distributed substantially circumferentially throughout the interior of the second cover assembly 220B functioning as a shared cover assembly. Openings 225B in the first side portion 222B may be formed so as to correspond to the arrangement of stator end windings 205 and/or busbars 210 at the corresponding axial end portion of the stator 206 of the first of the two electric motors. Openings 225B in the second side portion 224B may be formed so as to correspond to the arrangement of stator end windings 205 and/or busbars 210 at the corresponding axial end portion of the stator 206 of the second of the two electric motors. Thus, the oil can be forced out of the inlet passage 235B, for example, under pressure, through the plurality of openings 225B formed in first side portion 222B and the second side portion 224B of the cover assembly 220B, for cooling of the busbars 210 and/or the stator end windings 205 at the corresponding axial end portion of the stator 206 of each of the two electric motors.

FIG. 5A is a side view, FIG. 5B is a perspective view, and FIG. 5C is a partial perspective view, of a portion of the example electric motor 200 shown in FIGS. 2A-2C, with a portion of the example cover assembly 220 removed so that portions of the busbars 210 and portions of the stator end windings 205 are visible.

As shown in FIGS. 5A-5C, the plurality of busbars 210 are arranged circumferentially relative to the stator end windings 205, with spaces formed between adjacent busbars 210. The spaces formed between the adjacent busbars 210 facilitate the flow of oil between the adjacent busbars 210, as shown by the arrow F in FIG. 5A. In the example shown in FIGS. 5A-5C, each of the plurality of busbars 210 is individually fabricated and individually coated, for example with a dielectric material, or powder coated. An inner holder 240 and an outer holder 250 maintain a relative position of the stator end windings 205 and the busbars 210. In some examples, the inner holder 240 and/or the outer holder 250 can be made of an injection molded material. As shown in FIGS. 5A-5C, the outer holder 250 includes a plurality of legs 252 that define a plurality of openings 254, or windows 254, between adjacent legs 252. The legs 252 have a first end portion coupled to one of the busbars 210, and a second end portion coupled to the stator 206. The openings 254, or windows 254, further facilitate the flow of oil to the plurality of busbars 210 and the stator end windings 205, as shown by the arrow F in FIG. 5A. The example arrangement of legs 252 and openings/windows 254 of the outer holder are provided for purposes of discussion and illustration. The outer holder 250 can include more, or fewer legs 252, defining more, or fewer openings/windows 254 between adjacent legs 252, depending on, for example size of the rotor 208, size of the stator end windings 205, cooling flow rates, cooling flow requirements, and other such factors.

In some examples, the spaces between adjacent busbars 210 and/or the openings 254, or windows 254 formed by the spaces between the legs 252 of the outer holder 250 may facilitate drainage of cooling oil from the cavity in which the busbars 210 and the stator end windings 205 are installed and the drain channel 290 shown in FIGS. 2A-2C. That is, in some situations, inefficient and/or insufficient drainage of oil that has been circulated for cooling can result in hotspots, foaming, high viscous losses, overheating and the like. The improved drainage characteristics provided by the spacing between adjacent busbars 210 and the openings 254, or windows 254 between adjacent legs of the outer holder 250 may improve overall performance, function and reliability of the electric motor 200.

A dual sided axial stator cooling system, in accordance with implementations described herein, includes at least one cover assembly at a corresponding axial end portion of the stator. The at least one cover assembly can receive cooling fluid, for example, via a supply nozzle portion in fluid communication with a source of cooling fluid, and can discharge the cooling fluid from the cover assembly in an axial direction, toward the stator. The plurality of openings defined in the ring portion of the cover assembly facilitates the axial discharge of cooling fluid from the cover assembly. As noted above, for example with respect to FIGS. 1A-1G, the plurality of openings in the cover assembly are not necessarily the same size and/or shape, are not necessarily uniformly and/or symmetrically arranged. The axial discharge of cooling fluid from the cover assembly and toward the stator may direct cooling to the stator end windings, busbars and the like, and can provide for a more uniform flow distribution of cooling fluid, thus improving overall cooling of the electric motor and improving overall system performance and reliability.

Terms such as “substantially” and “about” used herein are used to describe and account for small fluctuations, such as due to variations in processing. Also, when used herein, indefinite articles such as “a” or “an” may refer to “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, any logic flows depicted herein do not require the particular order shown, or sequential order, to achieve desirable results. In addition, other processes may be provided, or processes may be eliminated, from the described flows, and other components may be added to and/or removed from the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An axial cooling system for a drive system, the axial cooling system comprising:
at least one cover assembly configured to be coupled to an axial end portion of an electric motor of the drive system, the at least one cover assembly including:
a first side portion configured to face the stator;
a second side portion coupled to the first side portion so as to form a passage therebetween;
a plurality of openings defined in the first side portion; and
a supply nozzle portion in fluid communication with the plurality of openings via the passage defined between the first side portion and the second side portion, wherein the plurality of openings are configured to receive cooling fluid from the supply nozzle portion, and to discharge the cooling fluid in an axial direction toward a stator of the electric motor.

2. The axial cooling system of claim 1, wherein the at least one cover assembly includes:
a first cover assembly configured to be coupled to a first axial end portion of the electric motor, wherein the first cover assembly is configured to discharge the cooling fluid in a first axial direction and onto stator end windings at the first axial end portion of the electric motor; and
a second cover assembly configured to be coupled to a second axial end portion of the electric motor, wherein the second cover assembly is configured to discharge the cooling fluid in a second axial direction and onto stator end windings at the second axial end portion of the electric motor.

3. The axial cooling system of claim 1, wherein the plurality of openings in the first side portion are arranged circumferentially about a central axis of the at least one cover assembly, corresponding to a central longitudinal axis of the stator.

4. The axial cooling system of claim 1, wherein the plurality of openings in the first side portion are arranged irregularly about a central axis of the at least one cover assembly.

5. The axial cooling system of claim 1, wherein a size and a shape of the plurality of openings are substantially the same, and wherein the plurality of openings are arranged substantially equidistant from each other along a circumferential portion of the first side portion of the at least one cover assembly, corresponding to an arrangement of stator end windings at the axial end portion of the electric motor.

6. The axial cooling system of claim 1, further comprising a plurality of busbars configured to supply power to the stator, wherein the plurality of busbars are arranged circumferentially between an axial end portion of the stator and the at least one cover assembly, with spaces formed between adjacent busbars of the plurality of busbars such that cooling fluid discharged through the plurality of openings in the at least one cover assembly flows through the spaces formed between adjacent busbars.

7. The axial cooling system of claim 6, wherein each of the plurality of busbars is individually coated with a dielectric material.

8. The axial cooling system of claim 6, further comprising:
a first holder positioned at an inner circumferential position relative to the plurality of busbars; and
a second holder positioned at an outer circumferential position relative to the plurality of busbars,
wherein the first holder and the second holder are configured to secure a position of the plurality of busbars relative to a plurality of stator end windings at the axial end portion of the stator.

9. The axial cooling system of claim 8, wherein the second holder includes:
a plurality of leg portions each having a first end coupled to a busbar of the plurality of busbars and a second end portion coupled to the axial end portion of the stator; and
a plurality of windows formed between adjacent leg portions of the plurality of leg portions.

10. The axial cooling system of claim 8, wherein the first holder and the second holder are injection molded.

11. The axial cooling system of claim 1, wherein the plurality of openings defined in the first side portion comprises a plurality of first openings, the at least one cover assembly further comprising a second plurality of openings defined in the second side portion.

12. The axial cooling system of claim 11, wherein the supply nozzle portion is in fluid communication with the first plurality of openings and with the second plurality of openings via the passage defined between the first side portion and the second side portion.

13. The axial cooling system of claim 12, wherein
the first plurality of openings are configured to receive cooling fluid from the supply nozzle portion and to discharge the cooling fluid in an axial direction toward a stator of a first electric motor of the drive system, the first electric motor being positioned at a first side of the at least one cover assembly; and
the second plurality of openings are configured to receive cooling fluid from the supply nozzle portion and to discharge the cooling fluid in an axial direction toward a stator of a second electric motor of the drive system, the second electric motor being positioned at a second side of the at least one cover assembly.

14. An axial cooling system for a drive system, the axial cooling system comprising:
at least one cover assembly configured to be coupled to an axial end portion of an electric motor of the drive system, the at least one cover assembly including:
a first side portion configured to face the stator;
a second side portion coupled to the first side portion so as to form a passage therebetween; and
means for receiving cooling fluid into the passage, and for discharging the cooling fluid from the passage in an axial direction toward a stator of the electric motor.

15. The axial cooling system of claim 14, wherein the at least one cover assembly includes:
a first cover assembly configured to be coupled to a first axial end portion of the electric motor, wherein the first cover assembly is configured to discharge the cooling fluid in a first axial direction and onto stator end windings at the first axial end portion of the electric motor; and
a second cover assembly configured to be coupled to a second axial end portion of the electric motor, wherein the second cover assembly is configured to discharge the cooling fluid in a second axial direction and onto stator end windings at the second axial end portion of the electric motor.

16. The axial cooling system of claim 14, wherein the plurality of openings in the first side portion are arranged circumferentially about a central axis of the at least one cover assembly, corresponding to an arrangement of stator end windings at the axial end portion of the electric motor.

17. The axial cooling system of claim 14, further comprising a plurality of busbars configured to supply power to the stator, wherein the plurality of busbars are arranged circumferentially between an axial end portion of the stator and the at least one cover assembly, with spaces formed between adjacent busbars of the plurality of busbars such that cooling fluid discharged through the plurality of openings in the at least one cover assembly flows through the spaces formed between adjacent busbars.

18. The axial cooling system of claim 17, further comprising:
a first holder positioned at an inner circumferential position relative to the plurality of busbars; and
a second holder positioned at an outer circumferential position relative to the plurality of busbars,
wherein the first holder and the second holder are configured to secure a position of the plurality of busbars relative to a plurality of stator end windings at the axial end portion of the stator.

19. The axial cooling system of claim 14, wherein the plurality of openings defined in the first side portion comprises a plurality of first openings, and wherein the at least one cover assembly further comprises a second plurality of openings defined in the second side portion, wherein the plurality of first openings and the plurality of second openings are in fluid communication with the passage defined between the first side portion and the second side portion.

20. The axial cooling system of claim 19, wherein
the first plurality of openings are configured to discharge cooling fluid from the passage in a first axial direction toward a stator of a first electric motor of the drive system, the first electric motor being positioned at a first side of the at least one cover assembly; and
the second plurality of openings are configured to discharge cooling fluid from the passage in a second axial direction toward a stator of a second electric motor of the drive system, the second electric motor being positioned at a second side of the at least one cover assembly.
